(19) United States
(12) Patent Application Publication
(10) Pub. No.: US 2009/0241415 A1
(43) Pub. Date: Oct. 1, 2009

(54) Vessel for Planting Plants or Flowers, and Its Planar Development

(75) Inventor: Lido Barghini, Larciano (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: BARGHINI PLAST 2 S.R.L., Larciano (PT) (IT)

(21) Appl. No.: 12/066,278

(22) PCT Filed: Sep. 14, 2006
(86) PCT No.: PCT/IB06/02529

§ 371 Date: Jun. 12, 2008

(30) Foreign Application Priority Data
Sep. 15, 2005 (IT) PI2005A00098

(51) Int. Cl. A01G 9/02; B29C 45/00

(52) U.S. Cl. 47/65.5; 264/328.1

(57) ABSTRACT

A vessel for planting plants or flowers has features particularly useful in the field of flower/plant-growing thanks to the advantages for the growth and vegetation of the plants as well as the savings in the transport and storage activities of the vessels themselves. The vessel provides, uniformly arranged in its lateral surface, a quantity of cavities and housings apt to promote the correct growth of the roots; it is made in plastic material through a manufacturing method whose output is preferably the planar development both of the lateral surface and of the base surface of the vessel. The planar development is so utilized during the phases of transport and storage of the vessel, which, in this case, is composed on site at the moment of its utilization, through simple assembling operations.

### FIELD OF THE INVENTION

The present invention concerns a vessel for planting plants or flowers.

The invention also concerns the planar development of a vessel for planting plants or flowers.

### DESCRIPTION OF THE PRIOR ART

It is known that vessels for planting plants or flowers are widely used, in various shapes and sizes, both in a private/public sector, in habitations, shops, offices, or as a decoration for streets, squares or public buildings, and in the trade/industrial sector, in hot-houses and plant/flower nurseries.

While in the private/public sector are utilized vessels with certain aesthetic features, by virtue of their material, their shape and the presence of decorations on their external surfaces, on the contrary, in the trade/industrial sector are used plastic vessels, of various sizes, with a quite standardized shape, and very little care is taken of their aesthetic appearance, because they are designed mainly for the easy of use and the reduction of the costs for their provision and utilization. As regards this second class of vessels, it is to notice that, in view of the cost-containment, a single plant is kept in the same vessel as long as it is possible, often until the plant itself is sold, and from this comes, as can be easily understood and verified, that the roots are constrained and grow in an anomalous manner, in fact they tend to got tangled and thicken close to the internal lateral surface of the vessel. As a consequence it produces not only a slower growth of the plant, but, mainly, a difficult recovery of the vegetation even when the plant is transferred in a different vessel, that is what usually happens upon purchase.

It is also to notice that the vessels, of different sizes according to the different types and sizes of the plants that they have to house, are produced, carried and managed with their final configuration of use, in it is clear that because of the waste of space due to their shape, the costs of transport, supplying and stocking are certainly penalized.

In order to prevent the above disadvantages, the professionals of this sector are since time trying to develop useful solutions, still with care to the general rules of reducing the costs in this sector.

### SUMMARY OF THE INVENTION

Main aim of this invention is to propose a vessel for planting plants which guarantee a proper conservation and vegetation of the plant for enough long periods.

Further aim of the invention is to propose a vessel for planting plants which has features useful to prevent waste of space during its transport and stocking phases. Such aims are attained through a vessel, in plastic material or similar semirigid material, for planting plants comprising a lateral surface coupled with a base surface, said lateral surface being provided with cavities and housings which can be, or not, in communication with the outer space. Said lateral surface is advantageously composed of one or more planar surfaces connected together in a series, the end sides of said surface, or series of surfaces, being linked together through rapid fastening means.

The cavities and housings on the lateral surface of the vessel are protrusions, having preferably a truncate conical shape, directed both towards the inside and towards the outside of the vessel, and they have sizes suitable to allow the growth of the plant's roots.

At least some of the outside protrusions are provided with apertures in their external surfaces.

The rapid fastening means, provided to link together the opposite sides of the surface, or series of surfaces, which compose the lateral surface of the vessel, are advantageously made by elastic catch elements of the protrusions placed in correspondence of said opposite sides, said protrusions overlapping in the configuration of normal use of the vessel.

A planar development of the vessel for planting plants, according to the present invention provides a first planar surface, provided with cavities and housings, designed to form the lateral surface of the vessel, and a second planar surface, designed to form the base of the vessel.

The above said surfaces composing the planar development of the vessel are advantageously made through a single injection moulding.

It is obvious that the vessel of the invention designed as in the above produces undoubted advantages both as regards the overall production and utilization costs and as regards the efficiency for the conservation and growth of the housed plants.

The chance of making the vessel in two separate phases allows to obtain, in a first phase, a configuration very useful for its storage and delivering to the place of use, where it is finally composed in its normal configuration of a vessel.

### BRIEF DESCRIPTION OF THE DRAWINGS

However, for a better understanding of the above-mentioned advantages and characteristics of the present invention, this will now be described by way of embodiment examples, with reference to the accompanying drawings, in which:

FIG. 1 shows a perspective view of a vessel for planting plants or flowers according to the invention;

FIG. 2 shows a detailed view, in section, of a portion of the vessel of FIG. 1;

FIG. 3 shows a planar development of the vessel of FIG. 1;

FIG. 4 shows a further planar development of a different embodiment of the vessel of the invention.

### DESCRIPTION OF PREFERRED EMBODIMENTS

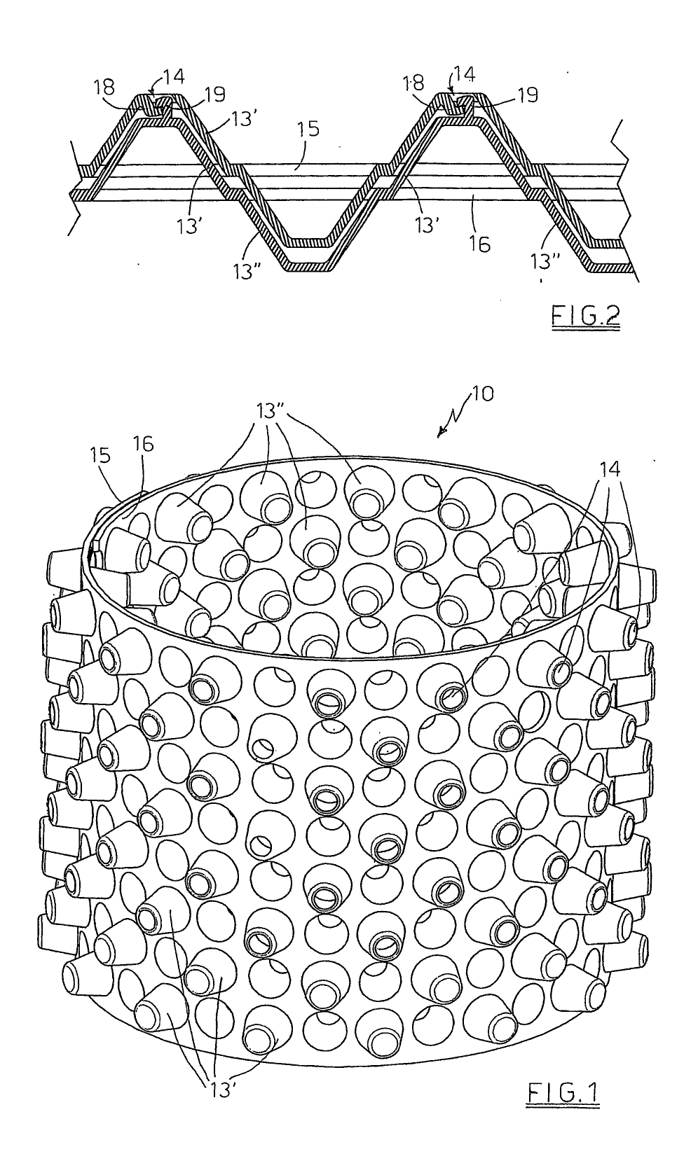

Referring to FIG. 1, it is labelled, as a whole, with 10, a vessel for planting plants, or flowers, according to the invention. The embodiment shown in said figure refers, in particular, to a vessel having a substantially cylindrical shape, comprising a substantially tubular lateral surface, 11, and a circular base surface, 12, visible in FIG. 3.

On the lateral surface, 11, there are, uniformly distributed, protrusions, 13, directed both towards inside and towards outside the vessel. Said protrusion are respectively disposed according to alternate rows; they are hollow truncate conical protrusions, and their size is apt to house the roots of the growing plant. In particular, it has to be noticed that all the protrusions rising towards the outside, 13′, except the ones placed in the lower portion of the vessel, are provided with circular apertures, 14, placed in their end surface, said apertures being apt to ensure a uniform growth of the roots. In fact, the roots grow inside said protrusions, while the stop growing when they come out the vessel, through said apertures. This, in addiction, prevents the roots wrapping themselves around the vessel.

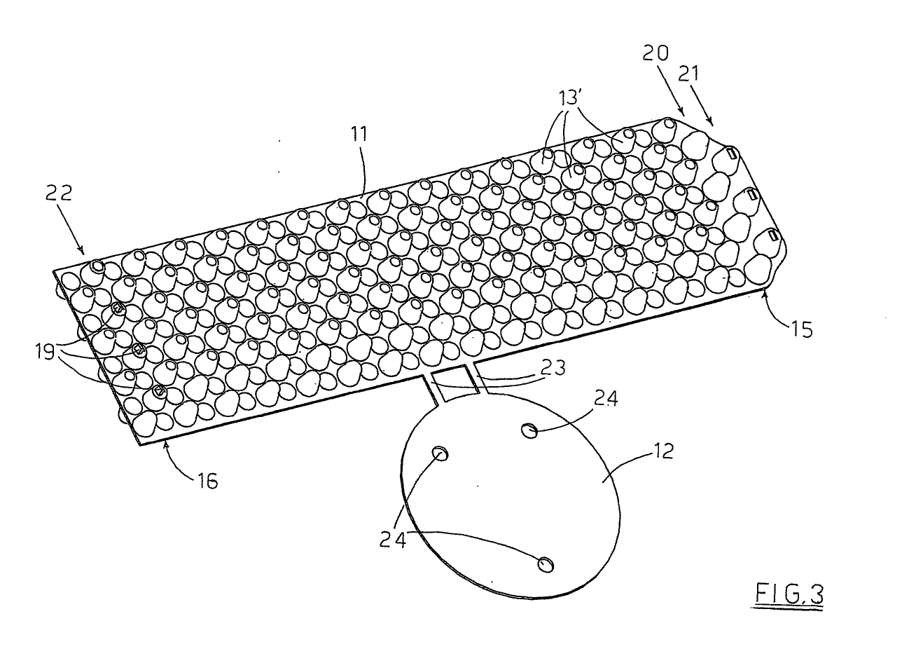

As it can be seen in the left part of FIG. 1, in this embodiment of the invention, the lateral surface 11 is obtained by bending on itself a planar development surface, well shown in FIG. 3, whose end portions, 15, 16, are overlapped and coupled. They are coupled simply by superimposing the portion 15 to the portion 16 and pressing one against the other to cause a snap catch through catching elements, 18, 19, which are, respectively, inside the protrusions integral to the portion 15, and outside the protrusions integral to the portion 16, as shown in FIG. 2, which represents a partial section of the vessel according to a vertical plane crossing the overlapping sections of the two end portions of the lateral surface.

In FIG. 3 are clearly shown the last two rows, 20, 21, of protrusions, 13′, apt to overlap the protrusions on the other side, 16, of the planar surface 11; in particular, the protrusions of the most external row, 21, are provided with hooks, 18, apt to couple with the hooks, 19, of the corresponding protrusions of the row, 22, placed in the opposite portion, 16, of the planar surface 11.

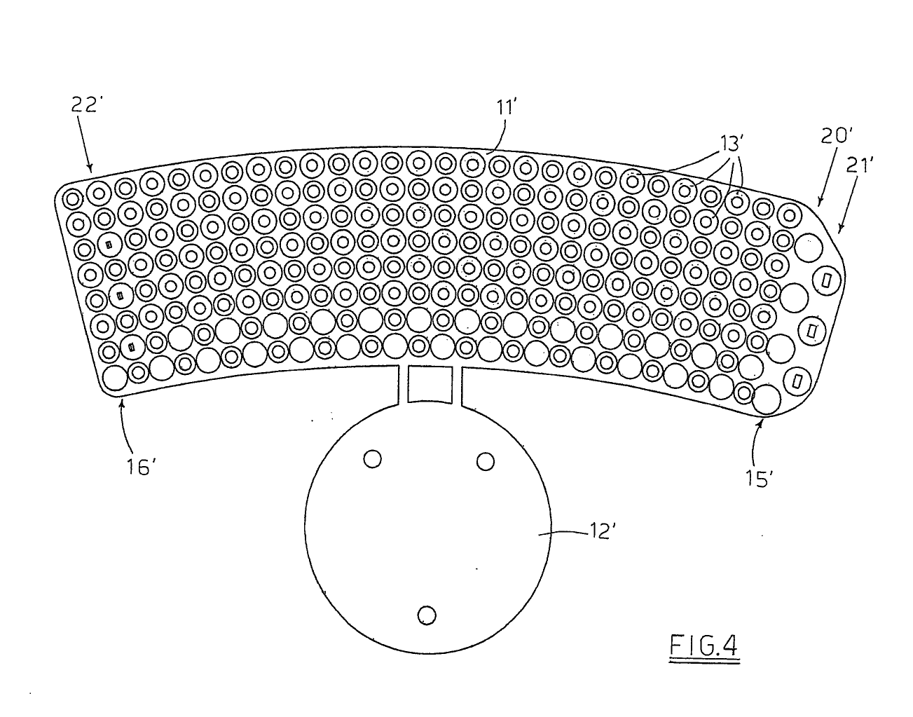

A similar arrangement and location of the cavities and housings, provided, or not, with catching elements, there is in surface 11′ shown in FIG. 4, and relating to a different embodiment of the invention. In this case, the vessel has such a planar development as to obtain, once composed, a flared vessel, that is with a reverse truncated conical shape.

It has to be noticed that, also in this embodiment, the protrusions placed along the lowest two rows are not provided with apertures communicating with the outside in order to maintain a certain rate of humidity in the lower portion of the vessel. Proper leakage holes are anyway provided in the base surface, 12.

It is also to be noticed that, both in the embodiment of FIG. 3 and in the one of FIG. 4, the base surface and the lateral surface of the vessel are produced through a single injection moulding phase. The two surfaces are connected together through simple thin flat links, 23, of the same material of said surfaces, so easily detachable and removable when the vessel has to be configured in its shape of utilization.

Such configuration is fast and easy to obtain. In fact, once detached the two surfaces, upon breakage and removal of the two links 23, the base surface is placed between the last and the second last horizontal rows of protrusions of the lateral surface while this last is bended and closed on itself so that said base surface is automatically restrained in such position when the two end portions of said lateral surface are bound each other by said snap catch means as above disclosed or by other means.

The advantages relating efficiency during the use and savings in the transport and storage costs of the vessel according to the invention are clear from what above disclosed.

Obviously, the above advantages still keep valid also carrying out changes or modifications to what above described, such as, for instance, changing the shape, as the one of the embodiment of FIG. 4, or different shapes which could be a prismatic shape, with flared or parallel sides, made by setting together planar surfaces or directly by moulding, even if, in this last case, the advantages relating the logistics of the vessel are lost.

Further changes may concern, for example, the number and the arrangement of the cavities and housings which there are in the lateral surface of the vessel. In fact, obviously, they can cover the external side of the vessel.

Even the shape of the cavities and housings may be different from the truncate conical shape of the above disclosed embodiments.

According to the type and size of the plants also the overall dimensions of the vessel may vary, as its lateral surface can be composed by connecting in a series two or more surface having a planar development. The base surface may be obtained by a separate moulding process or by separately adding a plastic sheet.

These and more modifications may be carried out, anyway, within the ambit of protection of the following claims.

1. Vessel, in plastic material or similar semirigid material, for planting plants or flowers, comprising a lateral surface and a base surface, characterized in that said lateral surface provides cavities and housings apt to promote a correct growth of the roots of the housed plant.

2. Vessel (10) for planting plants or flowers according to claim 1, characterized in that said lateral surface (11, 11′) is composed of one or more planar surfaces connected together in a series, the end portions (15, 16) of said surface, or series of surfaces, being joined together by clinching, clamping, gluing, jointing or different means.

3. Vessel (10) according to claim 2, characterized in that said cavities and housings of the lateral surface of the vessel are protrusions (13) directed both towards the outside and towards the inside.

4. Vessel (10) according to claim 3, characterized in that said protrusions (13) have a truncated conical shape.

5. Vessel (10) according to claim 4, characterized in that at least some of the protrusions directed towards the outside (13′) provide apertures (14) in their end surfaces.

6. Vessel (10) according to claim 2, characterized in that the end portions (15, 16) of said surface, or series of surfaces, which form the lateral surface of the vessel, are joined together by rapid fastening means.

7. Vessel (10) according to claim 6, characterized in that said rapid fastening means are, advantageously, snap catching elements (18, 19) integral to said protrusions (13, 13′) located in correspondence of said end portions (15, 16) of said surface, or series of surfaces, (11, 11′).

8. Planar development of a vessel, in plastic material or similar semirigid material, for planting plants or flowers, characterized in that it comprises at least a first planar surface (11) apt to be the lateral surface of said vessel, and at least a second planar surface (12) apt to be the base surface of said vessel.

9. Planar development according to claim 8, characterized in that said first planar surface (11, 11′) provides cavities and housings, the opposite end portions being joinable each other by clinching, clamping, gluing, jointing or different means.

10. Planar development according to claim 9, characterized in that at least some of said cavities and housings provide apertures (14).

11. Planar development according to claim 9, characterized in that said first planar surface (11, 11′) comprises rapid fastening means located in correspondence of its end portions (15, 16, 15′, 16′).

12. Planar development according to claim 8, characterized in that it is produced through a single injection molding phase.
